(19) United States
(12) Patent Application Publication
(10) Pub. No.: US 2008/0124188 A1
(43) Pub. Date: May 29, 2008

(54) Concrete Screws

(76) Inventors: Chen-Chih CHANG, Yongkang City (TW); Li-Hsun Yang, Yongkang City (TW); Ping-Hung Yang, Yongkang City (TW)

Correspondence Address: Dr. BANGER SHIA;Int''l Patent Office of Bang Shia, 102 Lindencrest Ct, Sugar Land, TX, 77479-5201, US

(21) Appl. No.: 11/773,427

(22) Filed: Jul. 4, 2007

(30) Foreign Application Priority Data
Mar. 8, 2006 (TW) 095213670

(51) Int. Cl. F16B 25/10

(52) U.S. Cl. 411/387.8

(57) ABSTRACT

The present invention pertains to a concrete screw comprising a threaded portion with threads spirally disposed thereon and a helical conveying portion. In particular, the outer diameter of the threads is greater than the diameter of the helical conveying portion, in which two angled surfaces formed on the end thereof; two flutes are respectively defined between the angled surfaces, a cutting edge is formed on the intersection of one side of each of angled surfaces and two flutes. While screwing, the screw can directly and facilely be firmly screwed into the wall, thus greatly saving the screwing time and increasing the screw efficiency.

### BACKGROUND OF THE INVENTION

1. Field of the Invention

The present invention relates to a screw, in particular a concrete screw that can facilitate the users to save the screwing time and to increase the screwing efficiency.

2. Description of the Related Art

Typically, users usually exert a screw or an anchor to fasten the objects to the wall, such as a concrete, masonry, or other rigid materials. As referring to FIG. 1, a conventional screw 1 comprises a screw head 11 and a shank 12 connected to the head 11; wherein, a plurality of threads 13 are spirally disposed on the shank 12. While screwing, due to that the threads 13 lacks of the screwing intensity and can not self-drill into the wall 10, users need to drill a bore via a drilling machine in advance (not shown in the figures) and subsequently screw the screw 1 into the wall 10, which would take lots of time and cause inconvenience in screwing.

An anchor 3 as shown in FIG. 2 comprises a shank 31, an anchor sleeve 32 disposed around the shank 31, and a nut 33 disposed on a side of the shank 31; wherein, the shank 31 includes a threaded portion 311 spirally disposed thereon, and an expansion section 312 formed on the end thereof. Furthermore, the nut 33 is screwed along with the threaded portion 311, and the expansion section 312 can be forced into the anchor sleeve 32.

Continuing with the aforementioned, while screwing, users have to use the drilling machine to drill a bore 301 on the surface of the wall 30 (not shown in the figures); further the anchor 3 is beaten by a hammer and inserted into the bore 301 (not shown in the figures), and the nut 33 is rotated by a wrench (not shown in the figures). The shank 31 thus removed out of the wall 30, and the expansion section 312 is thrust into the anchor sleeve 32, which is therefore expanded and secured within the bore 301. As a result, the anchor 3 can obtain the effect of fastening and keep in a non-removable state.

However, there are still some disadvantages while in operation:

### 1. Increasing the Screwing Time

Due to the configuration of the anchor 3, users have to drill a bore 301 on the surface of the wall 30 at the beginning and subsequently exert a hammer and a wrench to firmly secure the anchor 3 into the wall 30. However, it would substantially spend some time screwing the anchor into the wall.

### 2. Affecting the Efficiency of Screwing

Due to the configuration of the conventional invention, the anchor 3 can not be easily rotated out of the wall 30 after being secured within the wall 30; moreover, users need to carefully fasten the anchor 3 to the wall 30 to prevent the wrong screwing, which is complex to deal with. However, it would be inconvenient and inefficient for users while operating.

### SUMMARY OF THE INVENTION

The objects of the present invention are to provide a concrete screw for increasing the screwing efficiency and reducing the screwing time.

The concrete screw in accordance with the present invention comprises a threaded portion and a helical conveying portion attached to the threaded portion; wherein, a plurality of threads are spirally disposed on the threaded portion. The diameter of the helical conveying portion is smaller than the outer diameter of the threads of the threaded portion; moreover, two angled surfaces are formed at the distal end of the helical conveying portion, and simultaneously two flutes are respectively defined between the two angled surfaces; a cutting edge is formed on the intersection of one side of each of the angled surfaces and the flutes. According to the above configuration, users can directly fasten the screw to the wall without a predrilled bore drilled by a drilling machine, so as to decrease the screwing time and to increase the convenience in screwing.

The advantages of the present invention over the known prior art will become more apparent to those of ordinary skilled in the art upon reading the following descriptions in conjunction with the accompanying drawings.

### BRIEF DESCRIPTION OF THE DRAWINGS

FIG. 1 is a schematic view showing a state of screwing of a conventional screw;

FIG. 2 is a schematic view showing a state of screwing of another conventional anchor;

FIG. 3 is a schematic view showing the first preferred embodiment of the present invention;

FIG. 4 is a partial perspective view showing of the end of the helical conveying portion of the screw in the first preferred embodiment;

FIG. 5 is a schematic view showing a state of screwing of the first preferred embodiment;

FIG. 6 is a schematic view showing the state of the screwing of the first preferred embodiment, which is fastened to the wall via a clamp nut;

FIG. 7 is a schematic view showing the second preferred embodiment of the present invention;

FIG. 8 is a schematic view showing the third preferred embodiment of the present invention; and

FIG. 9 is a schematic view showing the fourth preferred embodiment of the present invention.

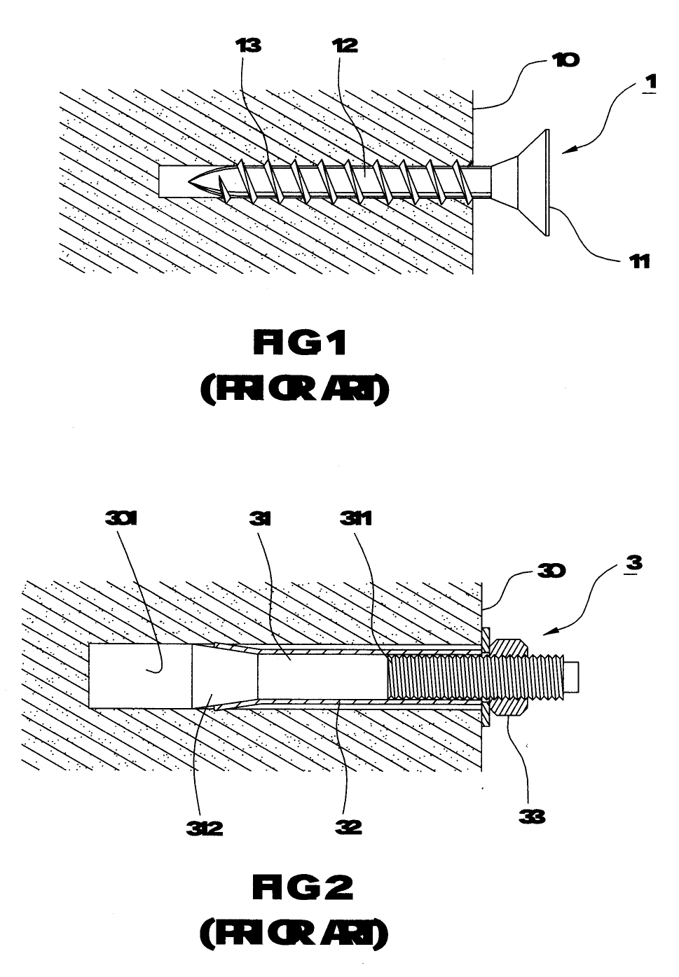

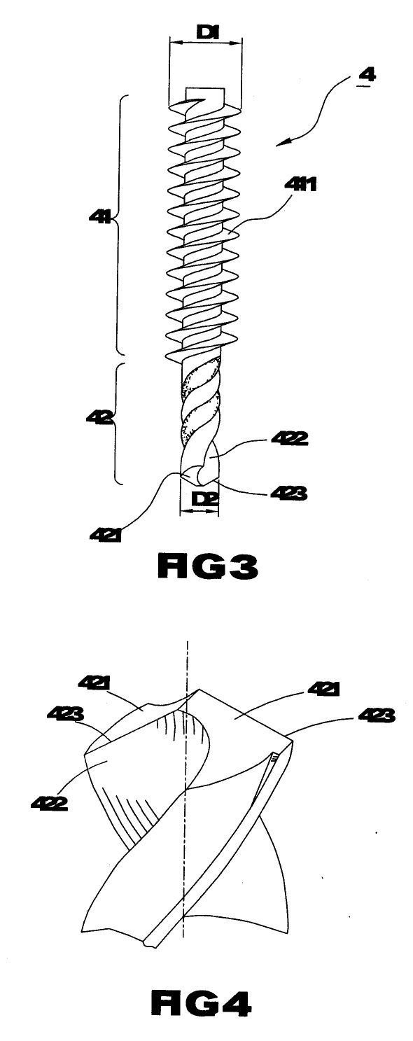

### DETAILED DESCRIPTION OF THE PREFERRED EMBODIMENTS

Before the present invention is described in greater detail, it should be noted that the similar elements are denoted by the same reference numerals throughout the disclosure.

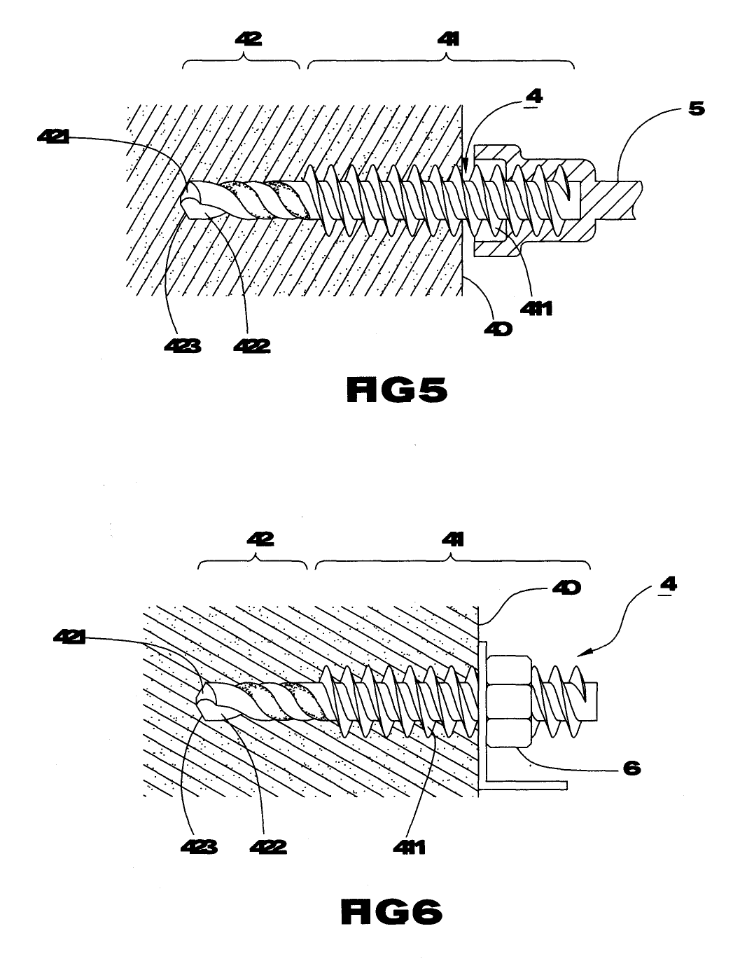

Referring to FIGS. 3 and 4, the concrete screw 4 of the first preferred embodiment comprises a threaded portion 41 and a helical conveying portion 42 disposed adjacent to the threaded portion 41; wherein, a plurality of threads 411 are spirally disposed on the threaded portion 41; furthermore, the outer diameter èD1è of the threads 411 of the threaded portion 41 is greater than the diameter èD2è of the helical conveying portion 42; the helical conveying portion 42 comprises two angled surfaces 421 formed at the distal end thereof, and two flutes 422 are respectively defined between the angled surfaces 421 and extended axially to the helical conveying portion 42; a cutting edge 423 is thus formed on the intersection of one side of each of the angled surfaces 421 and each of the flutes 422.

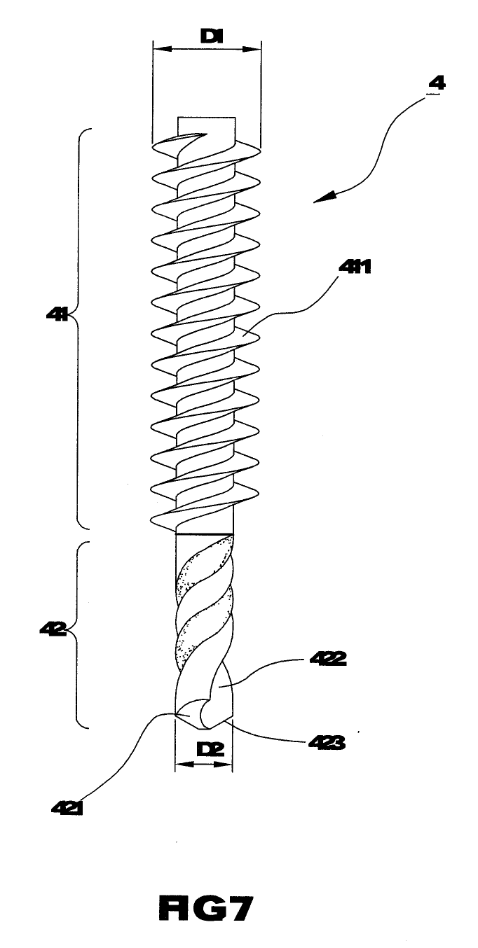

As shown in FIG. 5, while in operation, first, the angled surfaces 421 of the helical conveying portion 42 are guided in a direction toward the wall 40; further, the threaded portion 41 are inserted into a sleeve 5 for being driven with a tool (not shown in the figures), and synchronously the helical conveying portion 42 is also rotated and drilled into the wall 40, so as to drill a bore on the surface thereof. The debris generated from the bore can be discharged by the flutes 422. While screwing from the helical conveying portion 42 to the threaded portion 41, the threads 411 can easily and quickly drill into the wall 40 due to the preparatory bore drilled by the helical conveying portion 42, the concrete screw 4 hence can be firmly fastened to the wall 40 and the screwing time would be greatly reduced.

In particular, as shown in FIG. 6, part of the threaded portion 41 can also protrude out of the wall 40, and a clamp nut 6 is disposed thereon, thereby enhancing the fastening capability. Accordingly, the concrete screw 4 can also be screwed out of the wall 40 in reverse direction after fastening the screw 4 to the wall 40, so as to improve the problem of the wrong screwing.

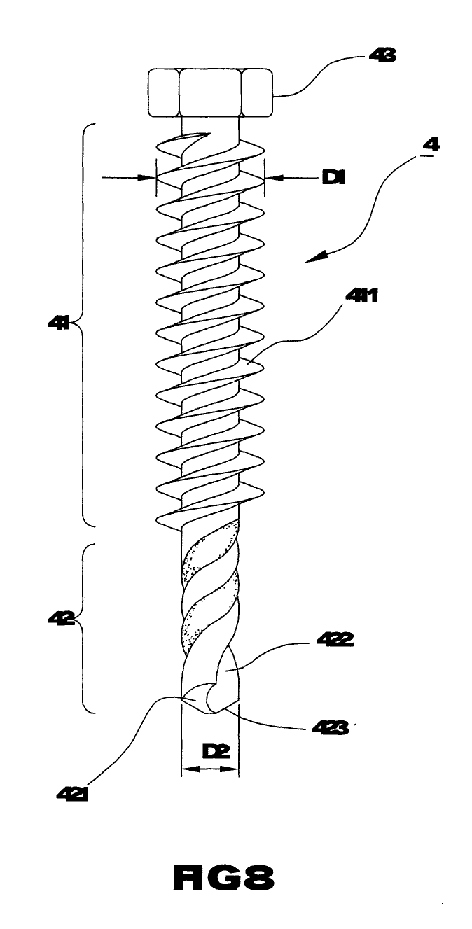

Referring to FIG. 7, the concrete screw 4 of the second preferred embodiment of the present invention comprises a threaded portion 41 and a helical conveying portion 42; similarly, the other configurations and the effects of the screw 4 are the same as the first embodiment. To be more specific, both the threaded portion 41 and the helical conveying portion 42 are made of different materials and are joined by welding, which means that the material of helical conveying portion 42 is harder than the material of threaded portion 41 for being facilely drilled the screw 4 into the wall 40.

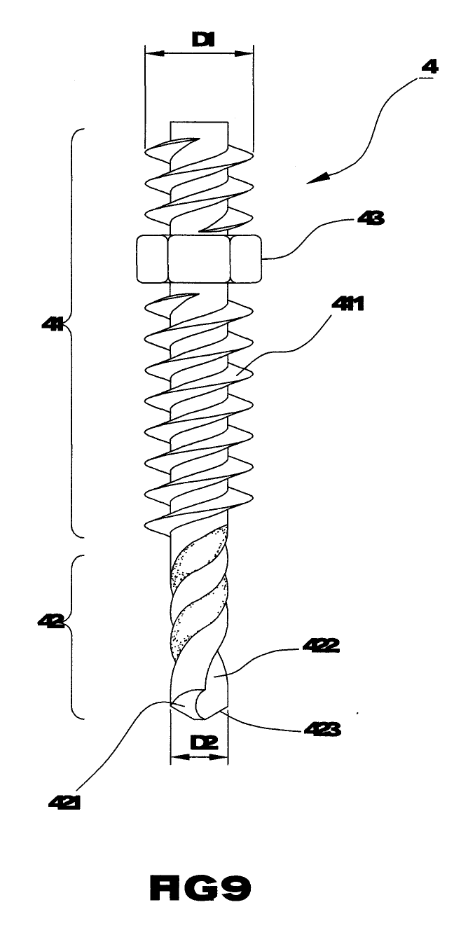

Referring to FIGS. 5 and 8, the concrete screw 4 of the third preferred embodiment of the present invention still includes a threaded portion 41 and a helical conveying portion 42; further the other configurations and the effects of the screw 4 are also the same as the first embodiment. Particularly, a holding section 43 is disposed on the apex of the threaded portion 41 or is disposed between the helical conveying portion 42 and the apex of the threaded portion 41 (as shown in FIGS. 8 and 9), which is for adapting and fitting into the sleeve 5 of the drilling machine and facilitates to fasten the screw 4 to the wall 40.

According to above description, the present invention has following advantages and functions:

### 1. Greatly Reducing the Screwing Time

Due to the helical conveying portion attached to threaded portion of the concrete screw, the screw can be easily drilled into the wall without drilling a preparatory bore into the wall by a drilling machine, so as to increase the efficiency of screwing and save time in screwing.

### 2. Withdrawing the Screw from the Wall while in Wrong Drilling

The screw can be screwed out of the wall in reverse direction by a partial threaded portion protruded out of the wall, hence to improve the problem of the conventional anchor, which can not be easily rotated out of the wall after screwing.

To sum up, the present invention takes advantage of the helical conveying portion adjacent to the threaded portion for self-drilling and smoothing the debris away, which facilitates the screw to be firmly fastened into the wall, so as to increase the screwing efficiency and decrease the screwing time.

While we have shown and described the present invention with reference to the specific preferred embodiment, it should be clear to those skilled in the art that further embodiments may be made without departing from the scope of the present invention.

I claim:

1. A concrete screw comprising:
a threaded portion; wherein, a plurality of threads are spirally disposed thereon; and
a helical conveying portion disposed adjacent to said threaded portion; wherein, the diameter of said helical conveying portion is smaller than the outer diameter of said threads of said threaded portion; said helical conveying portion has two angled surfaces formed at the end thereof; two flutes are respectively defined between said two angled surfaces and are extended axially to said helical conveying portion; a cutting edge is defined on the intersection of one side of each of said two angled surfaces and each of said two flutes.

2. The concrete screw as claimed in claim 1, wherein said threaded portion and said helical conveying portion are made of different materials and can be joined by welding.

3. The concrete screw as claimed in claim 1, wherein said threaded portion provides with a holding section located on the apex thereof.

4. The concrete screw as claimed in claim 1, wherein said holding section is disposed between the apex of said threaded portion and said helical conveying portion.
